(19) United States
(12) Patent Application Publication
(10) Pub. No.: US 2017/0105519 A1
(43) Pub. Date: Apr. 20, 2017

(54) STAND

(71) Applicant: TPV-INVENTA TECHNOLOGY CO.,LTD., Taipei City (TW)

(72) Inventors: Jiun-Hong WANG, Taipei City (TW); Pei-Ju TSAI, Taipei City (TW); Chieh LAI, Taipei City (TW); Kaun-Chang SHAO, Taipei City (TW)

(21) Appl. No.: 15/133,137

(22) Filed: Apr. 19, 2016

(30) Foreign Application Priority Data
Oct. 14, 2015 (TW) 104216450

(51) Int. Cl. A47B 23/06; G06F 1/16; A47B 23/04

(52) U.S. Cl. CPC A47B 23/06; A47B 23/04; G06F 1/16

(57) ABSTRACT

A stand includes a frame and a base. The frame includes a hook, a main body and a pivoting part. The main body is connected between the hook and the pivoting part. The hook has a groove, allowing the frame to be rotated relative to a rod by taking an extending direction of the groove as an axis of rotation. The base is pivoted to the pivoting part, allowing the base to be folded or unfolded relative to the frame so as to adjust an angle between the base and the main body of the frame.

### CROSS-REFERENCE TO RELATED APPLICATIONS

This non-provisional application claims priority under 35 U.S.C. §119(a) on Patent Application No(s). 104216450 filed in Taiwan, R.O.C. on 14 Oct. 2015, the entire contents of which are hereby incorporated by reference.

### TECHNICAL FIELD OF THE INVENTION

The disclosure relates to a stand, more particularly to a stand for supporting an electronic product.

### DESCRIPTION OF THE RELATED ART

Electronic products such as All-in-One Personal Computer (AIO PCs) become more and more indispensable in business or home environments. The AIO PC has small in size and can handle many tasks such as word processing, video streaming and website surfing.

### SUMMARY

The present disclosure provides a stand for placing the electronic product more freely.

One embodiment of the disclosure provides a stand including a frame and a base. The frame includes a hook, a main body and a pivoting part. The main body is connected between the hook and the pivoting part. The hook has a groove, allowing the frame to be rotated relative to a rod by taking an extending direction of the groove as an axis of rotation. The base is pivoted to the pivoting part, allowing the base to be folded or unfolded relative to the frame so as to adjust an angle between the base and the main body of the frame.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIGS. 1A-1B are conceptual views for showing a stand according to one embodiment of the present disclosure;

FIG. 2 is an exploded view of the stand in FIGS. 1A-1B;

FIGS. 3A-3C are side views of the stand hanged on a rod according to one embodiment of the present disclosure;

FIGS. 4A-4C are side views of the stand put on a carrier according to one embodiment of the present disclosure;

FIG. 5A is a partial enlarged bottom view of a flexible member in FIG. 3A;

FIG. 5B is a perspective view of a stand according to another embodiment of the present disclosure;

FIG. 6 is a partial enlarged view of a seat in FIG. 2; and

FIGS. 7-8 are partial enlarged cross-sectional views of a base in FIG. 1A.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

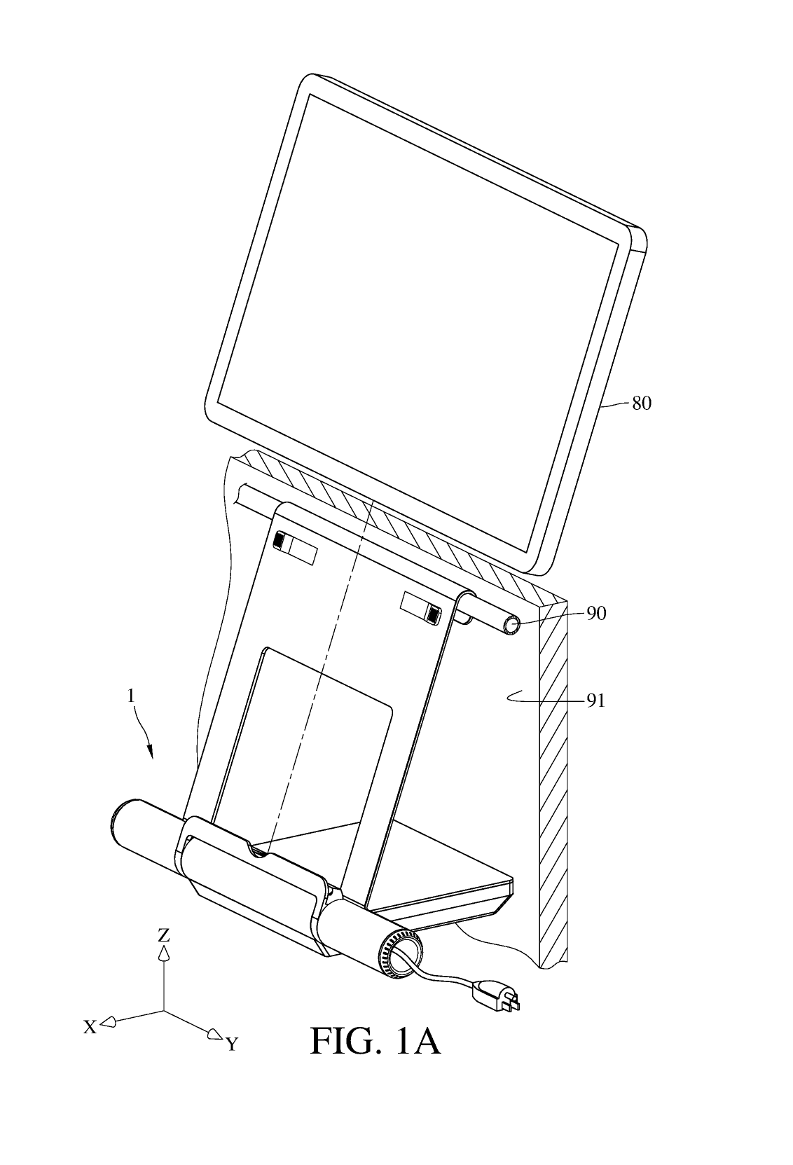

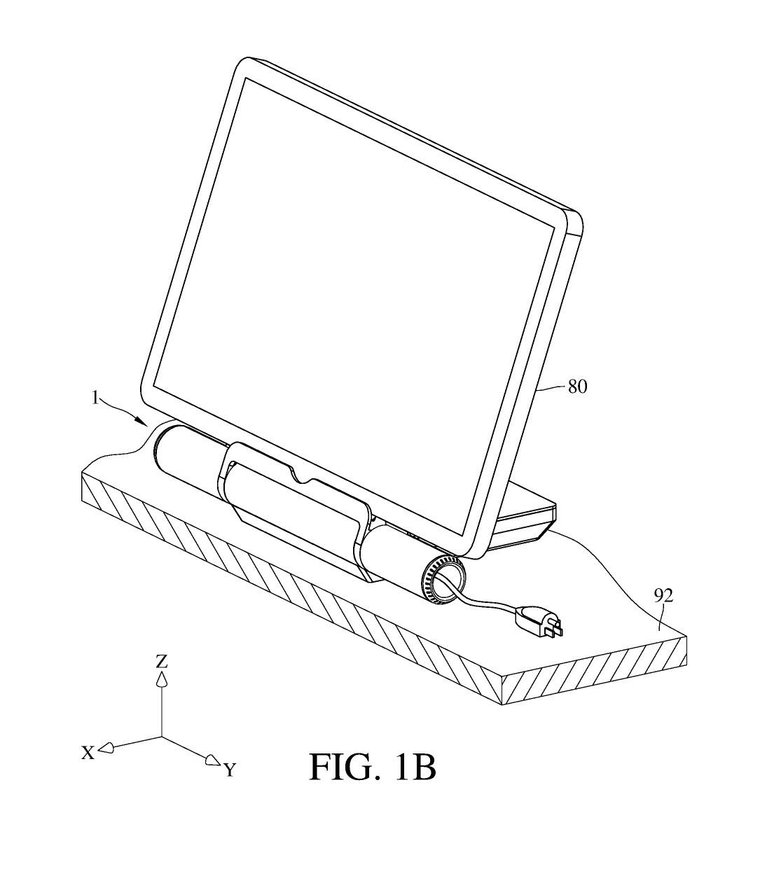

Please refer to FIGS. 1A-1B, which are conceptual views for showing a stand according to one embodiment of the present disclosure. As shown in FIG. 1A, a stand 1 is provided. The stand 1 is for holding or supporting an electronic device 80. The said electronic device 80 is a portable electronic device such as a tablet personal computer or an All-in-One personal computer (AIO PC). As shown in FIG. 1A, a user is able to hang the electronic device 80 on a rod 90 fixed on a wall 91 by putting on the stand 1. The said wall 91 is, for example, a wall in kitchen or toilet. The said rod 90 is a rod for hanging, for example, towel or kitchenware. As shown in FIG. 1B, the user is able to place the electronic device 80 on a carrier 92 via the stand 1. The said carrier 92 is, for example, a desk or a table.

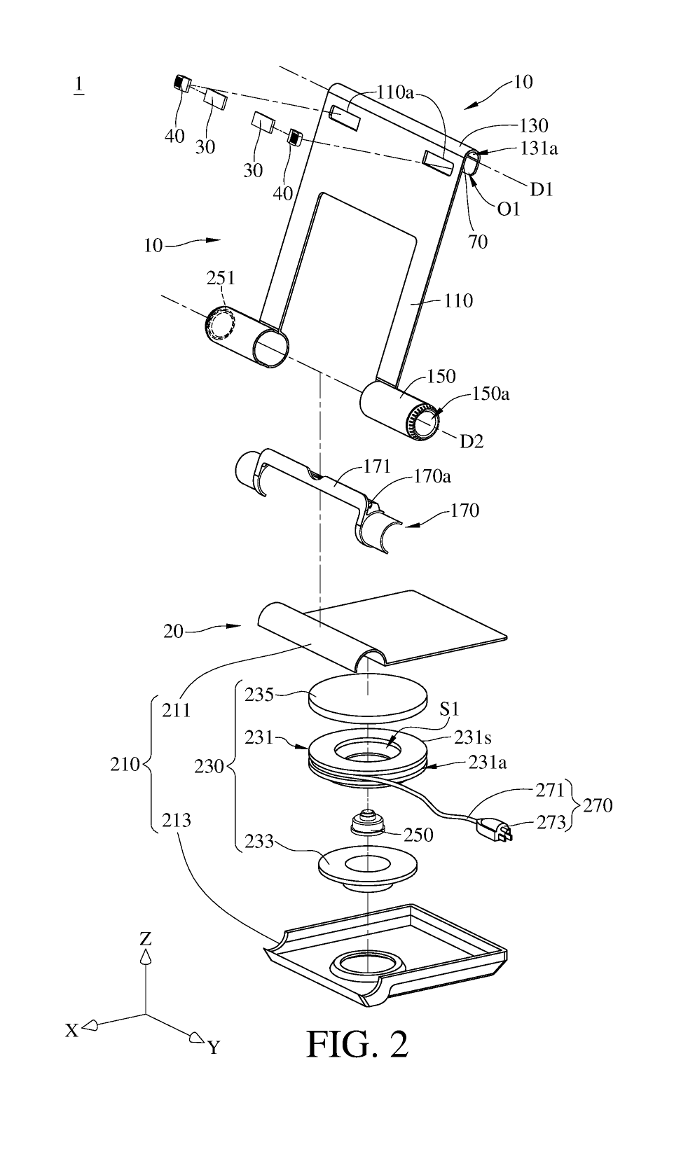

Then, please see FIG. 2, which is an exploded view of the stand in FIGS. 1A-1B. As shown in FIG. 2, the stand 1 includes a frame 10 and a base 20. The frame 10 includes a hook 130, a main body 110, a pivoting part 150 and a seat 170. The main body 110 is connected between the hook 130 and the pivoting part 150. The seat 170 is fixed on the pivoting part 150.

In detail, the hook 130 is a U-shaped hook. The hook 130 has a groove 131a. In FIG. 2, an extending direction D1 of the groove 131a is parallel to Y-axis. The groove 131a has an opening O1 facing the pivoting part 150.

The pivoting part 150 has a through hole 150a. In FIG. 2, an extending direction D2 of the through hole 150a is parallel to Y-axis. Thus, the extending direction D2 of the through hole 150a is parallel to the extending direction D1 of the groove 131a.

The seat 170 has a guide groove 170a and a front board 171. The guide groove 170a is for guiding the electronic device 80 to be placed in a desired position. The front board 171 is for preventing the electronic device 80 from falling off from the seat 170.

The base 20 is pivoted to the pivoting part 150 of the frame 10. Thus, the base 20 is able to be rotated relative to the frame 10 by taking the extending direction D2 of the through hole 150a as an axis of rotation.

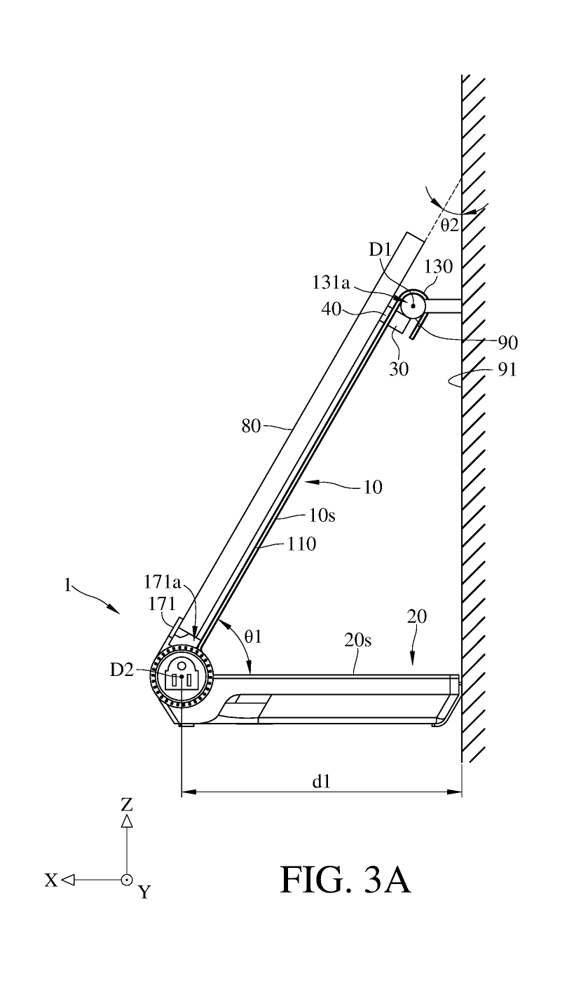

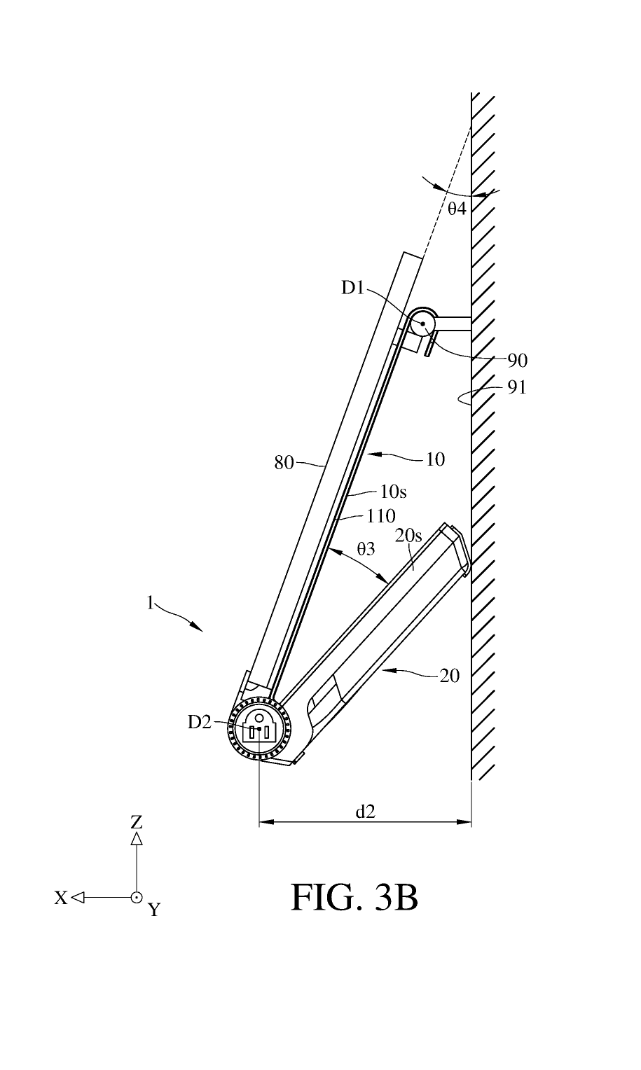

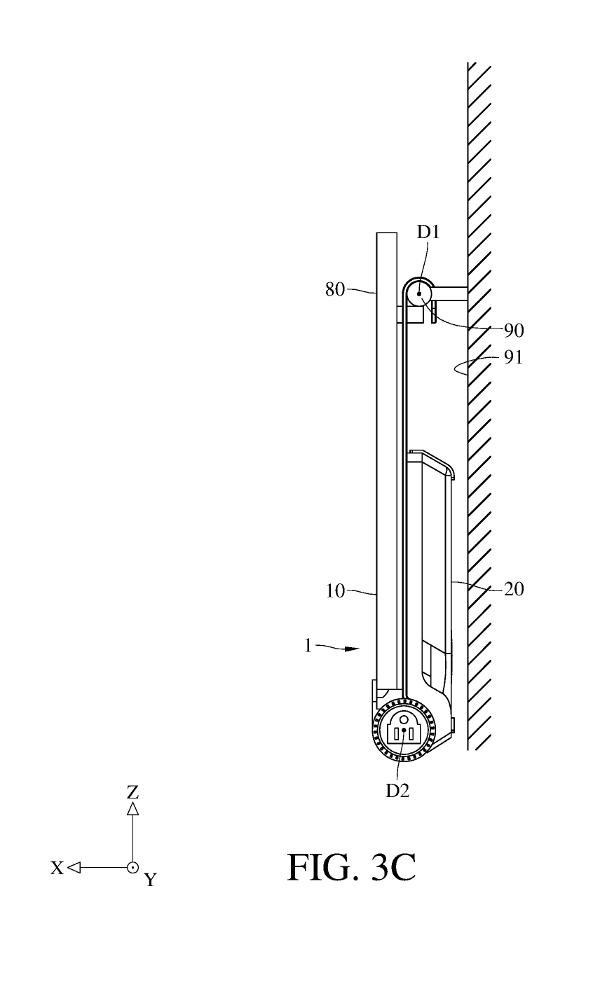

Then, please refer back to FIG. 1A and further refer to FIGS. 3A-3C, wherein FIGS. 3A-3C are side views of the stand hanged on a rod according to one embodiment of the present disclosure. As shown in FIG. 3A, the stand 1 is hanged on the rod 90 via the hook 130. One end of the base 20 is against the wall 91, which is able to stable the electronic device 80 when the user touches or pushes the electronic device 80. An angle θ1 is formed between a surface 10s of the frame 10 and a surface 20s of the base 20. An angle θ2 is formed between the surface 10s of the frame 10 and the wall 91. The extending direction D2 of the through hole 150a and the wall 91 is spaced a distance d1 from each other.

In addition, in view of FIG. 3A, the front board 171 is extended along a direction which is parallel to an extending direction of the main body 110. Thus, when the electronic device 80 is disposed on the guide groove 170a of the seat 170, the front board 171 is able to prevent the electronic device 80 from tilting.

The angle between the main body 110 of the frame 10 and the base 20 can be adjusted by rotating the rotating base 20, thereby adjusting the viewing angle of the electronic device 80. For example, from the point of view of FIG. 3B, the base 20 is rotated in a counter-clockwise direction, thus the angle between the surface 20s of the base 20 and the surface 10s of the frame 10 is decreased from the angle θ1 (as shown in FIG. 3A) to an angle θ3. Hence, the distance between the extending direction D2 of the through hole 150a and the wall 91 is decreased from the distance d1 (as shown in FIG. 3A) to a distance d2. The frame 10 is rotated about the extending direction D1 of the groove 131a, thus the angle between the surface 10s of the frame 10 and wall 91 is decreased from the angle θ2 (as shown in FIG. 3A) to an angle θ4. For another example, as shown in FIG. 3C, the base 20 is placed to be parallel to the frame 10 so that both the stand 1 and the electronic device 10 are parallel to the wall 91.

Accordingly, the view angle of the electronic device 80 is able to be adjusted by adjusting the aforementioned angle (e.g. angle θ1, angle θ2 or angle θ3) in order to comply with different viewing requirements.

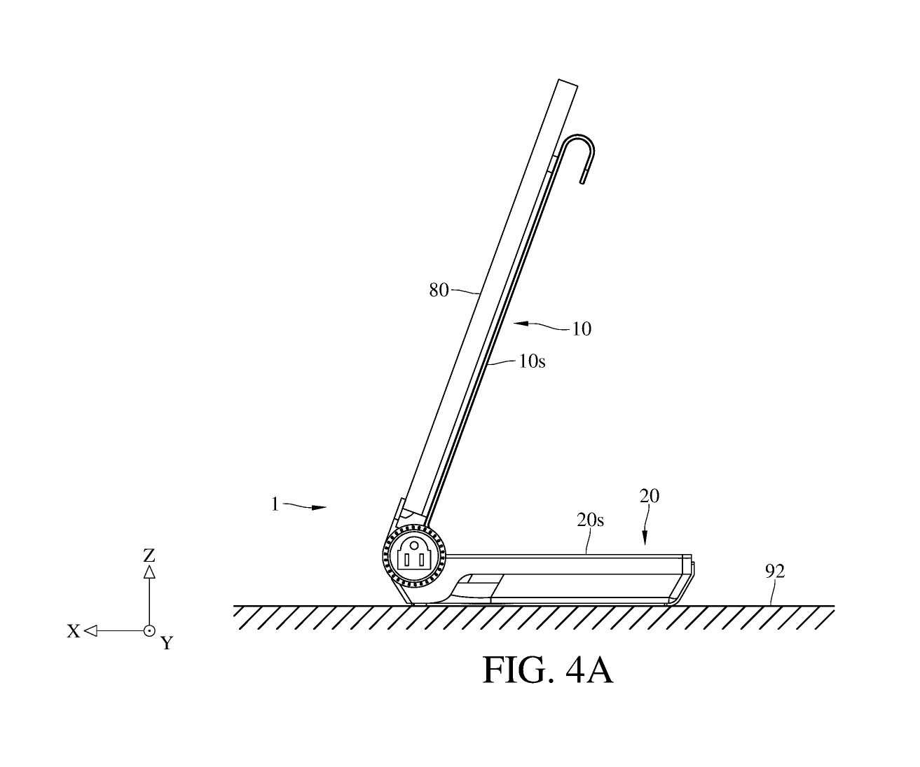

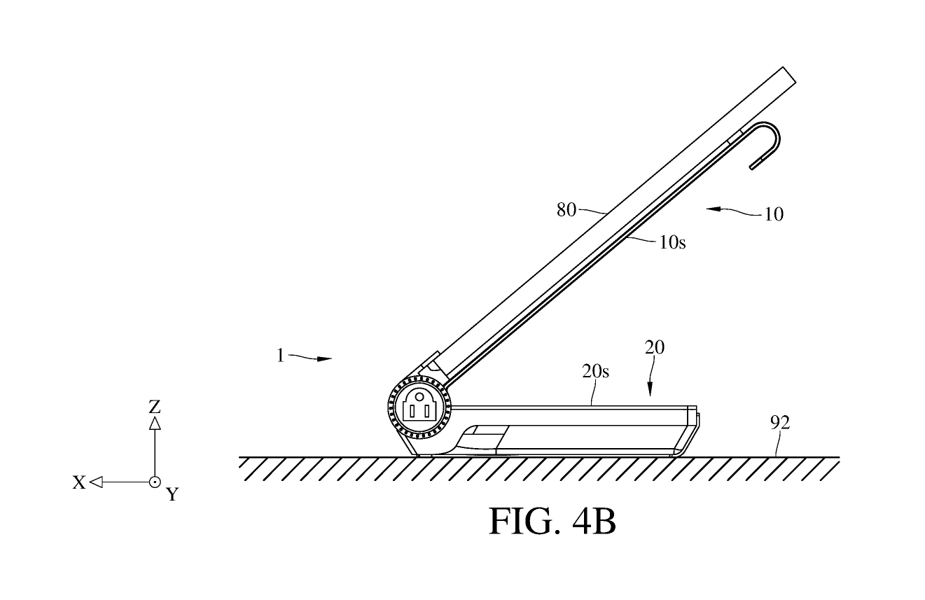

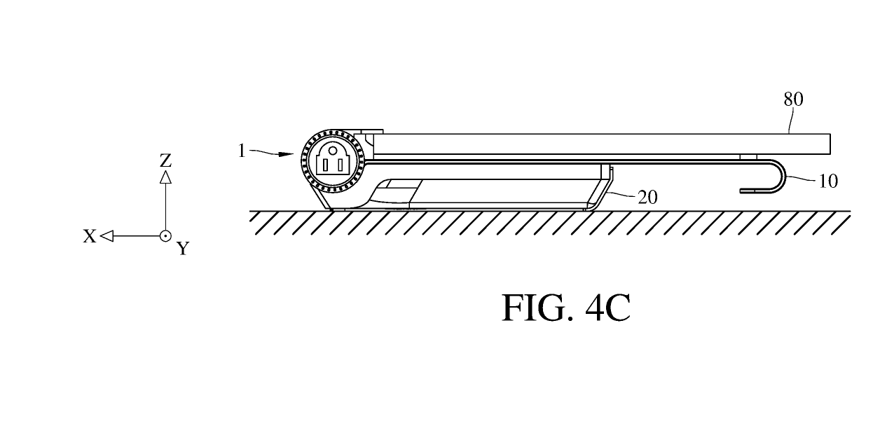

Then, please refer back to FIG. 1B and further refer to FIGS. 4A-4C, wherein FIGS. 4A-4C are side views of the stand put on a carrier according to one embodiment of the present disclosure. When the stand 1 is put on the carrier 92, the angle between the surface 10s of the frame 10 and the surface 20s of the base 20 can be adjusted by rotating the frame 10.

In addition, in this embodiment, there is a damping mechanism (not shown) disposed in the base 20 and pivoted to the frame 10 for improving the stability when using the electronic device 80.

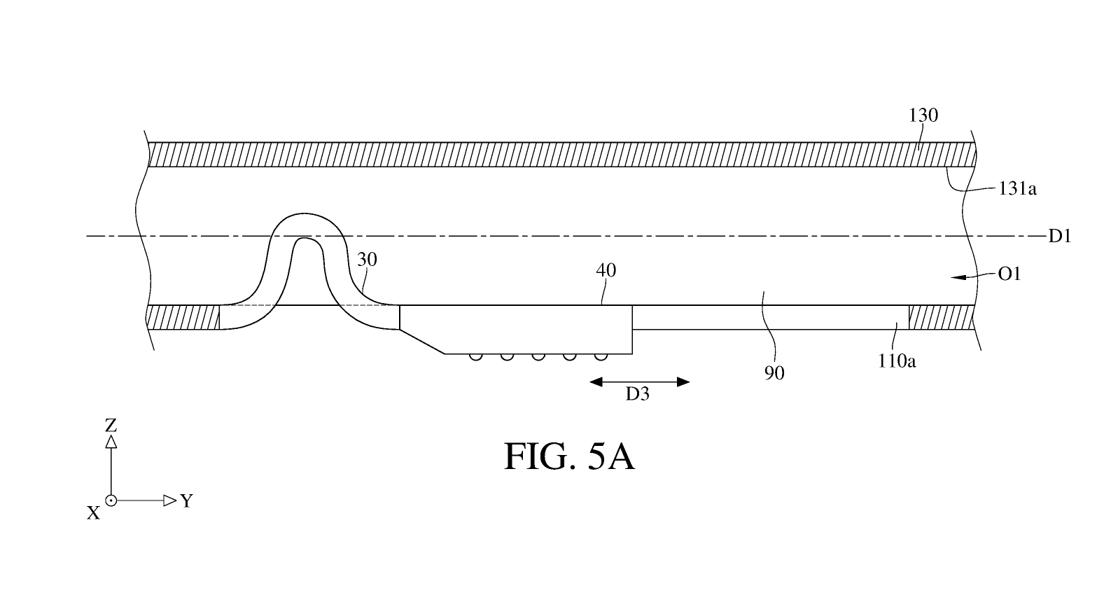

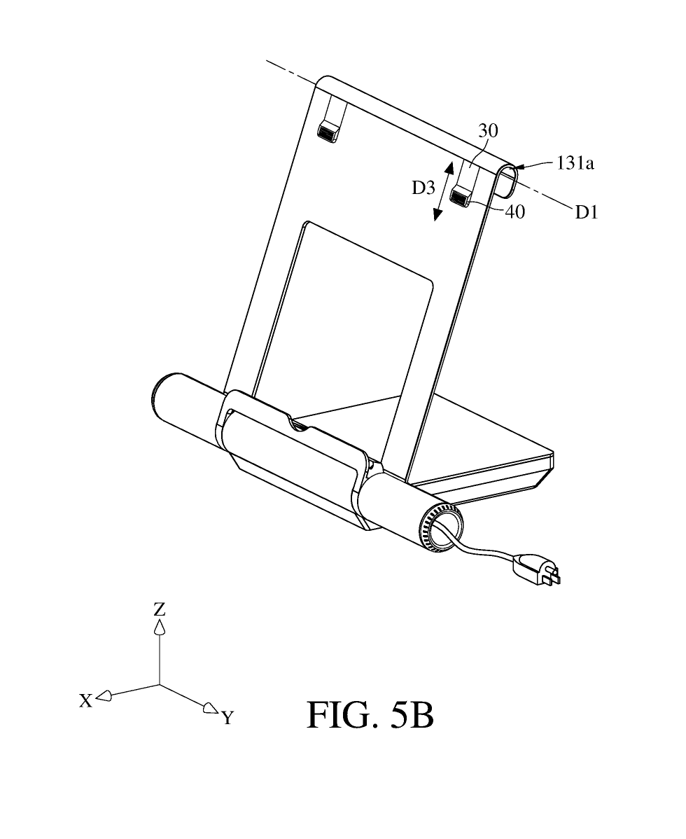

Then, please refer back to FIG. 2 and FIG. 3A and further refer to FIG. 5A, wherein FIG. 5A is a partial enlarged bottom view of a flexible member in FIG. 3A. In this embodiment, the stand 1 further includes two flexible members 30 and two slidable members 40. The main body 110 has two slots 110a. The slidable members 40 are slidably disposed in the slots 110a, respectively. Each of the slidable members 40 is moved in a sliding direction D3 which is parallel to Y-axis. It is noted that the sliding direction D3 is parallel to the extending direction D1 of the groove 131a. Two ends of the flexible member 30 which are opposite to each other are fixed to the slot 110a and the slidable member 40, respectively. The flexible member 30 is pressed and bent when the slidable member 40 is moved toward the flexible member 30. As shown in FIG. 5A, the bent part of the flexible member 30 protrudes from the slot 110a so as to block a part of the opening O1 of the groove 131a. In such a case, please refer back to FIGS. 3A and 3B, when the stand 1 is hanged on the rod 90, the rod 90 is able to be constrained in the groove 131a by the bent part of the flexible member 30. Hence, the hook 130 is securely fixed on the rod 90 so that the stand 1 is not easily disturbed or not easy to fall from the rod 90 by physically hitting the stand 1. That is, the stand 1 hanged on the rod 90 is more stable when the rod 90 is constrained by the bent flexible member 30.

However, the present disclosure is not limited to the level that the rod 90 is constrained by the bent part of the flexible member 30.

In addition, in this embodiment, the flexible member 30 is a plate-shaped member and made of, for example, flexible material such as rubber. The rubber has a relatively high degree of friction coefficient so that flexible member 30 is favorable to firmly hold or clamp the rod 90 in the groove 131a.

Furthermore, the present disclosure is not limited to the sliding direction D3. For example, please refer to FIG. 5B, which is a perspective view of a stand according to another embodiment of the present disclosure. In this embodiment, the sliding direction D3 is perpendicular to the extending direction D1 of the groove 131a.

The quantities of the flexible member 30, the slidable member 40 and the slot 110a can be altered according to actual requirements. In other embodiments, the quantity of the flexible member 30 can be one, the quantity of the slidable member 40 can be one, and the quantity of the slot 110a can be one.

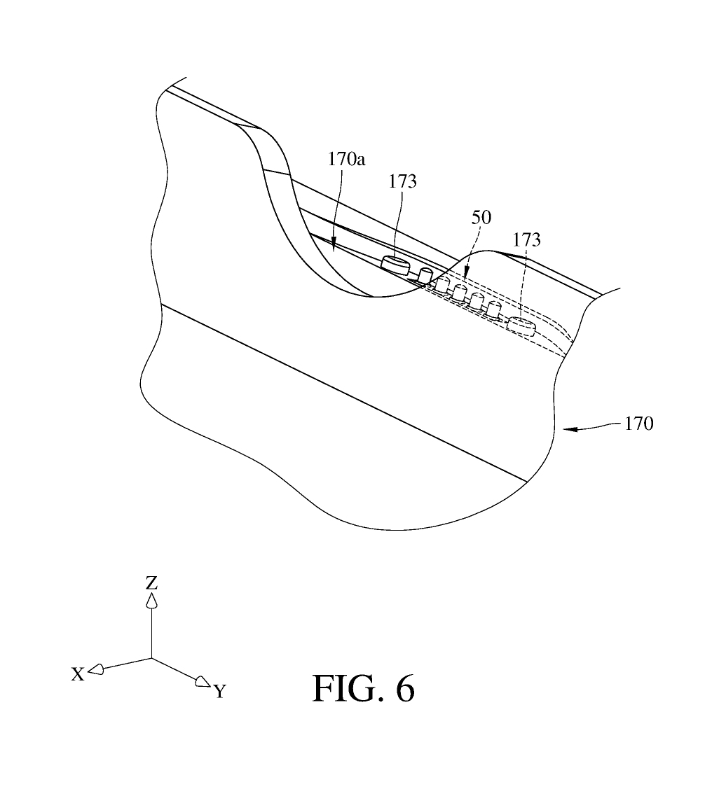

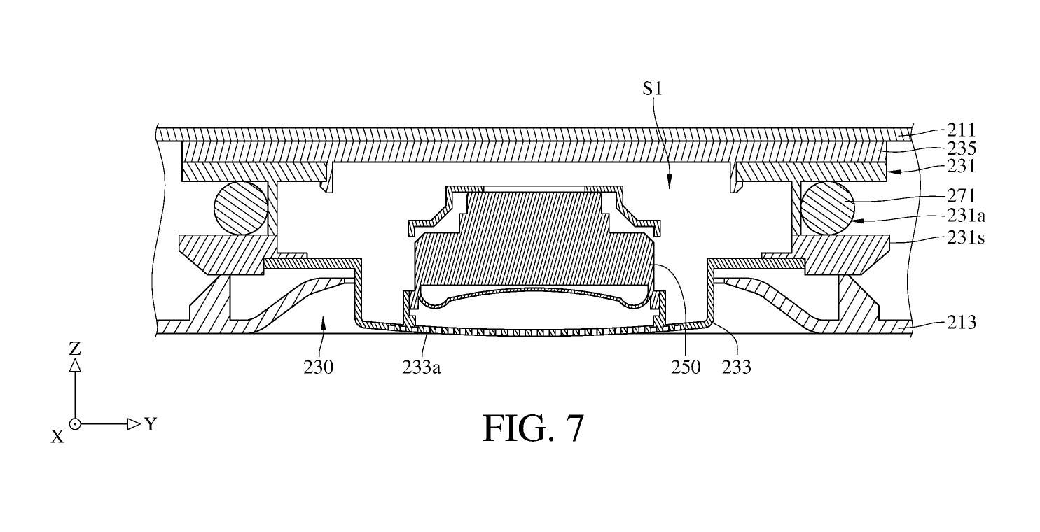

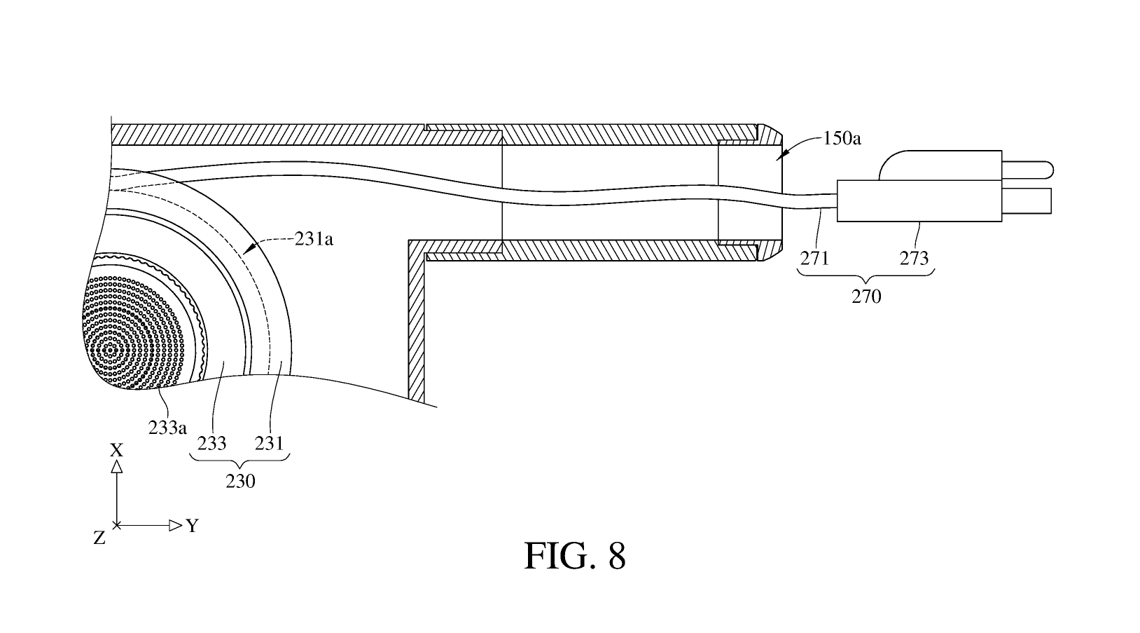

Then, please refer back to FIG. 2 and further refer to FIGS. 6-8, wherein FIG. 6 is a partial enlarged view of a seat in FIG. 2, and FIGS. 7-8 are partial enlarged cross-sectional views of a base in FIG. 1A. In this embodiment, the stand 1 further includes a connection port 50. The base 20 includes a case 210, a cord collector 230, a speaker 250 and a power cord 270.

In detail, as shown in FIG. 6, the connection port 50 is disposed on the guide groove 170a of the seat 170. The connection port 50 has, for example, a plurality of Pogo pins for electrically connecting the connection port (not shown) on the electronic device 80. As show in FIG. 1B, the electronic device 80 is able to be connected to the connection port 50 when the electronic device 80 is put on the guide groove 170a.

In addition, the seat 170 further has two positioning members 173 disposed on the guide groove 170a for positioning the electronic device 80 disposed on the guide groove 170a to be correctly connected to the connection port 50.

Then, as shown in FIG. 2 and FIGS. 7-8, the case 210 includes an upper case 211 and a lower case 213. The cord collector 230 is rotatably disposed to the upper case 211 of the case 210. Specifically, the cord collector 230 includes a rotatable part 231, a driving part 233 and a connecting part 235. The connecting part 235 is fixed to the upper case 211. The rotatable part 231 is rotatably disposed to the connecting part 235. The driving part 233 is disposed to a side of the rotatable part 231 which is opposite to the connecting part 235. The rotatable part 231 has an outer surface 231s and an annular groove 231a formed on the outer surface 231s. As shown in FIG. 8, the annular groove 231a is connected to the aforementioned through hole 150a. A part of the driving part 233 is protruding out of the lower case 213, thus the use is able to rotate the rotatable part 231 by rotating the driving part 233 from the outside of the case 210. However, the present disclosure is not limited to the position of the driving part 233.

In addition, the rotatable part 231, the driving part 233 and the connecting part 235 together define an accommodating space S1. The speaker 250 is disposed in the accommodating space S1. The accommodating space S1 is a resonator for the speaker 250. In this embodiment, the speaker 250 is, for example, a Bluetooth speaker. As shown in FIG. 7, there is a plurality of acoustic holes 233a formed on the bottom of the driving part 233. The acoustic holes 233a are allowing acoustic vibration from the speaker 250 to pass therethrough. In addition, as shown in FIG. 2, the base 20 further includes a volume controller 251 disposed on one side of the pivoting part 150 of the frame 10. In this embodiment, the volume controller 251 is a ring shaped member. The volume of the speaker 250 can be adjusted by rotating the ring shaped volume controller 251. However, the present disclosure is not limited to the shape of the volume controller 251.

As shown in FIG. 2 and FIG. 8, the power cord 270 includes a cable 271 and a plug 273. One end of the cable 271 is connected to the plug 273, and the other end of the cable 271 is fixed to the annular groove 231a of the rotatable part 231. The cable 271 of the power cord 270 is able to be coiled into the annular groove 231a by rotating the rotatable part 231. Since the annular groove 231a is connected to the aforementioned through hole 150a, the cord collector 230 is able to move the plug 273 to penetrate through the through hole 150a. For example, the user is able to pull the plug 273 and a part of the cable 271 out of the through hole 150a or coil the cable 271 and the plug 273 into the cord collector 230 by rotating the cord collector 230.

It is noted that the power cord 270 is electrically connected to the connection ports 50 by inner wires (not shown) connected therebetween. Thus, the user is able to plug the power cord 270 to an outer power source (not shown) for supplying power to the electronic device 80 connected on the connection port 50. However, the aforementioned cord collector 230, the speaker 250 and the power cord 270 are optional.

Moreover, please refer back to FIG. 2 and FIG. 3A, the stand 1 further includes a non-slip pad 70 disposed on the surface 10s of the hook 130 which forms the groove 131a. In this embodiment, the non-slip pad 70 is made of, for example, rubber which has a relatively high degree of friction coefficient. Thus, the hook 130 can be firmly disposed on the rod 90 by the non-slip pad 70. However, the non-slip pad 70 is optional, and the present disclosure is not limited to the position thereof.

Furthermore, in other embodiments, the stand 1 further includes a wireless charging module (not shown) for charging the electronic device 80.

According to the stand discussed above, when the stand is put on a table or hanged on a rod, the inclined angle of the frame is able to be adjusted by adjusting the angle between the frame and the base so as to adjust the view point of the electronic device on the frame in order to comply with different viewing requirements.

In addition, during charging, since the part of the power cord can be stored into the cord collector, the length of the power cord pulled out of the stand is prevent from being too long to obstruct the user when using the electronic device. Then, the user is able to store the power cord into the stand so as to prevent the power cord from scattering on the table or the ground as well as tangling with each other.

Furthermore, the accommodating space in the base is a resonator for the speaker for providing a more realistic sound experience.

What is claimed is:

1. A stand, comprising:
a frame comprising a hook, a main body and a pivoting part, the main body connected between the hook and the pivoting part, the hook having a groove for the hook to be disposed on a rod, allowing the frame to be rotated relative to the rod by taking an extending direction of the groove as an axis of rotation; and
a base pivoted to the pivoting part of the frame, allowing the base to be folded or unfolded relative to the frame so as to adjust an angle between the base and the main body of the frame.

2. The stand according to claim 1, further comprising at least one flexible member and at least one slidable member, the main body having at least one slot, the groove of the hook having an opening, the at least one slidable member slidably disposed in the at least one slot, two ends of the at least one flexible member which are opposite to each other fixed to the at least one slot and the at least one slidable member, respectively, wherein when the at least one slidable member is moved toward the at least one flexible member, a part of the at least one flexible member is bent and protruding out of the at least one slot to block a part of the opening of the groove.

3. The stand according to claim 2, wherein a sliding direction of the at least one slidable member is parallel to the extending direction of the groove.

4. The stand according to claim 2, wherein a sliding direction of the at least one slidable member is perpendicular to the extending direction of the groove.

5. The stand according to claim 1, wherein the base includes a case and a speaker disposed in the case.

6. The stand according to claim 1, further comprising a connection port and a power cord, wherein the pivoting part of the frame has a through hole, the base comprises a case and a cord collector, the connection port is disposed on the case, the cord collector is rotatably disposed in the case, the cord collector has a annular groove formed on an outer surface of the cord collector, the annular groove is connected to the through hole, the power cord is electrically connected to the connection port, one end of the power cord is fixed to the annular groove of the cord collector, the other end of the power cord is movably penetrating through the through hole, when the cord collector is rotated relative to the case, the cord collector moves the power cord to be coiled into the annular groove thereon.

7. The stand according to claim 6, further comprising a speaker disposed in an accommodating space of the cord collector.

8. The stand according to claim 1, further comprising a connection port, wherein the frame further comprises a seat fixed on the pivoting part, the seat has a guide groove and at least one positioning member, and the positioning member and the connection port are disposed on the guide groove.

9. The stand according to claim 2, wherein the quantity of the at least one flexible member is more than two, and the quantity of the at least one slot is more than two.

10. The stand according to claim 1, further comprising a non-slip pad disposed on a surface of the hook which is defining the groove.
